(19) United States
(12) Patent Application Publication
(10) Pub. No.: US 2010/0137760 A1
(43) Pub. Date: Jun. 3, 2010

(54) Medical Apparatus For Treatment Of The Human Or Animal Body By Pressure Waves Or Shock Waves

(76) Inventors: Manfred Schulz, Taegerwilen (CH); Ernst H. Marlinghaus, Bottighofen (CH); Josef Katona, Radolfzell (DE); Peter Christian Muelhauser, Berlingen (CH); Pavel Novak, Stetten (CH)

Correspondence Address: ST. ONGE STEWARD JOHNSTON & REENS, LLC, 986 BEDFORD STREET, STAMFORD, CT, 06905-5619, US

(21) Appl. No.: 12/627,778

(22) Filed: Nov. 30, 2009

Related U.S. Application Data
(63) Continuation of application No. PCT/EP2008/003986, filed on May 17, 2008.

(30) Foreign Application Priority Data
May 31, 2007 (DE) 20 2007 007 921.4

(51) Int. Cl. A61H 23/04

(52) U.S. Cl. 601/108

(57) ABSTRACT

A medical apparatus for treatment of the human or animal body by pressure waves or shock waves has a device designed to generate the pressure waves or shock waves and having at least one applicator part and a pneumatic drive which, by means of a pressurized gas, repeatedly generates impacts on a proximal input face of the applicator part in order, with the applicator part, to generate pressure waves or shock waves that are applied from the applicator part into the body by way of a distal output face. The pressurized gas acts, in the form of individual gas pressure pulses, directly on the applicator part to generate the pressure waves or shock waves.

### CROSS REFERENCE TO RELATED APPLICATIONS

The present application is a continuation of pending international patent application PCT/EP2008/003986 filed on May 17, 2008 which designates the United States, and which claims priority of German utility model application No. 20 2007 007 921.4 filed on May 31, 2007.

### BACKGROUND OF THE INVENTION

The invention generally relates to medical apparatus for treatment of the human or animal body by pressure waves or shock waves. More specifically, the invention relates to medical apparatus of the type comprising a device designed to generate the pressure waves or shock waves and having at least one applicator part and a pneumatic drive which, by means of a pressurized gas, repeatedly generates impacts on a proximal input face of the applicator part in order, with the applicator part, to generate pressure waves or shock waves that are applied from the applicator part into the body by way of a distal output face of the applicator part.

Within the meaning of the present invention, “treatment of the human or animal body” signifies, for example, treatment of soft tissue, in particular for alleviating pain, treatment of bone tissue, crashing of stones in the body, removal of plaque from vessels, treatment of teeth, but also removal of hone cement or driving-in of bone nails or wires.

A medical apparatus known from document DE 197 25 477 C2 is used for treatment of bone fractures, enthesopathies, tendinopathies and also periodontosis. Another field of use of this known apparatus is the treatment of pain in the soft-tissue area of the locomotor and support system located near bone. All these uses of the known medical apparatus can also be carried out with the medical apparatus according to the present invention.

The known apparatus comprises in addition to the applicator part, as a device for generating the pressure waves or shock waves, a percussion part or projectile which is accelerated pneumatically along an acceleration path and which, in order to generate the pressure waves or shock waves in the applicator part, repeatedly impacts against a proximal input face of the applicator part. By means of the impact of the percussion part or projectile on the resting applicator, pressure waves or shock waves are generated in the latter and are applied into the body of a patient by way of the distal output face of the applicator part when the distal output face is placed onto the surface of the patient's body.

The configuration of the medical apparatus with a device for generating pressure waves or shock waves, which has a percussion part or projectile moved to and fro along an acceleration path, has the disadvantage that the acceleration path needed for the percussion part or projectile means that the apparatus has a long structure. The known apparatus accordingly has a handpiece in which the applicator part is arranged and which is in the form of an elongate rod.

A further disadvantage of the known apparatus is that the percussion part or projectile and/or the applicator part are subject to wear that is caused by the repeated impact of the projectile on the applicator part.

Moreover, the document U.S. Pat. No. 5,425,735 discloses a medical apparatus which is used for crashing stones in the urinary tract and bladder or for crashing plaque in vessels and in which pressure waves or shock waves are generated in the applicator part by means of an electro-hydraulic converter. The electro-hydraulic converter comprises two electrodes which dip into a chamber filled with liquid. By applying high voltage to the electrodes, sparks are generated and trigger pressure waves or shock waves in the liquid, which pressure waves or shock waves then act on the proximal input face of the applicator part. Because of the electro-hydraulic converter, this known apparatus is expensive to produce.

### SUMMARY OF THE INVENTION

It is an object of the present invention is to improve a medical apparatus of the type mentioned at the outset in such a way that the aforementioned disadvantages are avoided and, in particular, such that the apparatus is of a small structure and is thus easy to handle.

According to an aspect of the invention, a medical apparatus for treatment of human or animal body by pressure waves or shock waves is provided, comprising a device designed to generate the pressure waves or shock waves, the device having at least one applicator part having a proximal input face and a distal output face, and a pneumatic drive which, by means of a pressurized gas, repeatedly generates impacts on the proximal input face of the applicator part in order, with the applicator part, to generate pressure waves or shock waves that are applied from the applicator part into the body by way of the distal output face, wherein the pressurized gas acts, in the form of individual gas pressure pulses, directly on the applicator part to generate the pressure waves or shock waves.

In the medical apparatus of the invention, the pressure waves or shock waves are accordingly generated with the at least one applicator part by means of individual gas pressure pulses that act directly on the proximal input face of the applicator part. Such a mechanism for generating pressure waves or shock waves means that the percussion part or projectile present in the known apparatus can be omitted and, in particular, also the associated long acceleration path for the percussion part or the projectile. The apparatus according to the invention can thus be made substantially smaller, in particular shorter, and thus more manageable. Moreover, because of the omission of the percussion part or projectile, the apparatus according to the invention is less prone to wear than the known apparatus.

A further advantage of the apparatus according to the invention is that, because of the omission of a linear acceleration path, it can have an ergonomic design. Whereas the known apparatus, because of the linear acceleration path, has an elongate handpiece that has to be held in the manner of a rod in an ergonomically unfavourable way in the hand, the apparatus according to the invention can have a handpiece in which the applicator part is arranged transverse to a longitudinal direction of the handpiece. This facilitates the handling of the apparatus during application of the pressure waves or shock waves to a patient.

A further advantage of the apparatus according to the invention is that the applicator can be subjected to impacts at a higher pulse frequency, whereas the pulse frequency in the known apparatus is limited by the acceleration of the projectile part.

In a preferred embodiment, the applicator part is mounted in a gas-tight manner in a housing.

The advantage of this measure is that the individual gas pressure pulses act on the applicator part essentially without any loss of pressure, such that all the energy of the gas pressure pulses can be utilized to generate the pressure waves or shock waves in the applicator part.

In a preferred embodiment, the applicator part is movable in the distal direction by a limited stroke and is pretensioned elastically in a proximal starting position.

According to this embodiment, the individual gas pressure pulses act on the applicator part resting in its proximal starting position, wherein the individual gas pressure pulses have the effect that the applicator part is moved in the distal direction by the limited stroke, after which the applicator part is again moved back elastically to its proximal starting position. In this way, oscillations of the applicator part can be generated, which likewise are applied into the body of the patient and have a therapeutic action. Particularly in the context of the treatment of pain and the treatment of soft tissues, the excursion of the applicator part by the limited stroke provides a massaging action in addition to the pressure waves or shock waves, and this further improves the therapeutic effect of the apparatus. The restoring movement of the applicator part can also take place actively, for example with compressed air.

The stroke of the applicator part is preferably less than 10 mm, preferably less than 5 mm.

In another preferred embodiment, the proximal input face of the applicator part on which the gas pressure pulses act measures at least 0.5 cm², preferably at least 1 cm².

According to this embodiment, the proximal input face of the applicator part has a sufficiently large surface area to be able to achieve a considerable force from a low amplitude of the gas pressure pulses, as a result of which the pneumatic drive can operate with low pressure, a fact that increases the operating safety of the apparatus according to the invention. The input face can also be the same size as the output face, or larger than the latter, in order to achieve especially forceful impacts with the applicator part.

In another preferred embodiment, the applicator part is made from a material of low specific weight, for example a light metal, plastic or wood.

The design of the at least one applicator part from a material of low specific weight leads, at a given amplitude of the gas pressure pulses, to a high speed of the applicator part and also permits in particular an even greater pulse frequency at which the gas pressure pulses can be applied to the applicator part.

In contrast to the known apparatus, the applicator part can in particular also be made from wood, because the absence of a projectile or percussion part impacting on the applicator part means that said applicator part can also be made from a less impact-resistant material such as wood. An applicator part made from wood has the advantage that wood is a skin-compatible natural material and in particular, when placed onto the surface of the body, feels warm because of the low heat conduction and heat capacity of wood. The applicator part can also be made from several materials.

In another preferred embodiment, the gas pressure pulses are controlled by at least one valve.

This has the advantage that the gas pressure pulses can be generated in a forcedly controlled manner via the at least one valve. Thus, as is provided for in another preferred embodiment, the frequency, the amplitude and/or the duration of the gas pressure pulses can be advantageously set in a defined manner and can also be changed. In this way, the action of the pressure waves or shock waves on the body area to be treated can be optimized according to the particular application.

In contrast to electromagnetically driven massage apparatus in which the oscillations/vibrations are generally sinus-shaped, it is possible, by controlling the gas pressure pulses, to generate other than sinus-shaped oscillation or vibration profiles. Moreover, in contrast to the known apparatus whose pneumatic drive comprises a percussion part or projectile, it is possible to generate a substantially greater gas throughput and, consequently, a greater force on the applicator part, even at high speeds thereof.

The at least one valve is preferably a solenoid valve.

A solenoid valve can advantageously be opened and closed with very short switching times, as a result of which it is possible in particular to achieve high pulse frequencies of the gas pressure pulses, which may considerably exceed 30 Hz.

In another preferred embodiment, the apparatus has a handpiece that comprises the at least one applicator part.

As has already been mentioned above, the handpiece, in contrast to the known apparatus, can be designed in an ergonomically optimized shape, in particular in a small size, which makes handling of the handpiece more ergonomic during application of the pressure waves or shock waves to a patient.

It is preferable if the handpiece has a mass of less than 700 g.

The advantage of this is that the handpiece allows handling without causing fatigue.

In another preferred embodiment, the ratio of mass of the handpiece to mass of the applicator part is greater than 25:1, preferably greater than 50:1.

The use of an applicator part of low mass compared to the mass of the handpiece has the advantage that the handpiece, during operation of the apparatus, is not subjected or is only minimally subjected to oscillations or vibrations, as a result of which the ease of handling of the handpiece is further improved.

In another preferred embodiment, the handpiece can be connected to a control device, in which case a plurality of handpieces are provided, and the control device detects the handpiece to which the control device is connected.

According to this embodiment, several different handpieces are made available which each have an applicator part of different design. When one of these handpieces is connected to the control device, the control device identifies automatically, by means of an identification circuit, the handpiece to which the control device is connected, and it can then predefine specific parameter ranges such as frequency, amplitude and/or duration of the gas pressure pulses. These predefined parameters can preferably be changed during the operation of the apparatus, in order to achieve an optimal effect of the pressure waves or shock waves on the area of the body.

In another preferred embodiment, the at least one valve is arranged in the handpiece.

This measure has the advantage that less gas is needed for the drive and, therefore, smaller compressed gas sources can also be used.

This measure is also of advantage together with the aforementioned measure according to which several different handpieces are provided. Thus, these different handpieces can also be equipped with different valves, so as to be able to adapt the respective handpiece, according to its purpose of application, optimally to the frequency, amplitude and/or duration of the gas pressure pulses.

As has already been mentioned above the frequency, the amplitude and/or the duration of the gas pressure pulses is/are adjustable.

It is also preferable if the frequency, the amplitude and/or the pressure can be adjusted on the handpiece.

This measure increases the user friendliness of the apparatus according to the invention, since the desired parameter adjustments can be effected by the operator directly on the handpiece, whereas an adjustment carried out on the aforementioned control device sometimes requires an interruption of the treatment procedure, since the control device is usually arranged further away from the patient.

In another preferred embodiment, the applicator part is exchangeable.

This measure is particularly advantageous if only one handpiece is provided since the exchangeable nature of the applicator part means that an applicator part that is best suited for the relevant treatment can be mounted on the handpiece.

It is preferable if several applicator parts are provided which differ from one another in terms of size, mass, material, shape of the distal output face and/or size of the distal output face.

With such a choice of applicator parts, it is possible to select the applicator part best suited to the respective treatment.

In another preferred embodiment, the output face of the applicator part has a shape that has different dimensions in different directions transverse to the longitudinal direction.

This has the advantage that the size of the applicator part surface coming into contact with the surface of the body differs depending on the orientation of the applicator part relative to said surface of the body.

The output face can be oval or elliptic, for example.

The output face of the applicator part can also be round and have a convex curvature.

In another preferred embodiment, the apparatus is soundproofed.

The advantage of this measure is that the apparatus according to the invention is quiet during operation, and the treatment is not adversely affected by loud noises.

In another preferred embodiment, a trigger element for triggering the individual gas pressure pulses in single operation and/or continuous operation is arranged on the handpiece.

This measure further improves the user friendliness of the apparatus according to the invention. The gas pressure can then be permanently ready and the individual gas pressure pulses are generated only when the trigger is actuated.

Further advantages and features will become evident from the following description and from the attached drawing.

It will be appreciated that the aforementioned features to be explained in more detail below can be used not only in the respectively cited combination, but also in other combinations or singly, without departing from the scope of the present invention.

### BRIEF DESCRIPTION OF THE DRAWINGS

An illustrative embodiment of the invention is depicted in the drawings and is described in more detail below with reference to said drawings, in which:

FIG. 1 shows a side view of a medical apparatus for treatment of the human or animal body by pressure waves or shock waves;

FIG. 2 shows the apparatus from FIG. 1 in a front view;

FIG. 3 shows a longitudinal section through the apparatus in FIG. 1, with parts of the apparatus being depicted by a block diagram.

### DETAILED DESCRIPTION OF A PREFERRED EXEMPLARY EMBODIMENT

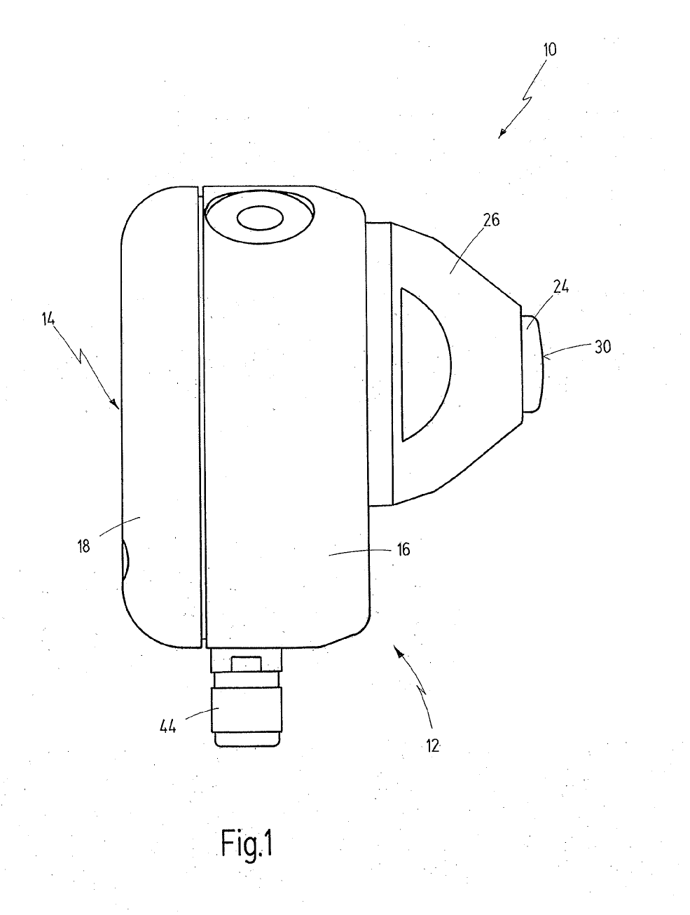

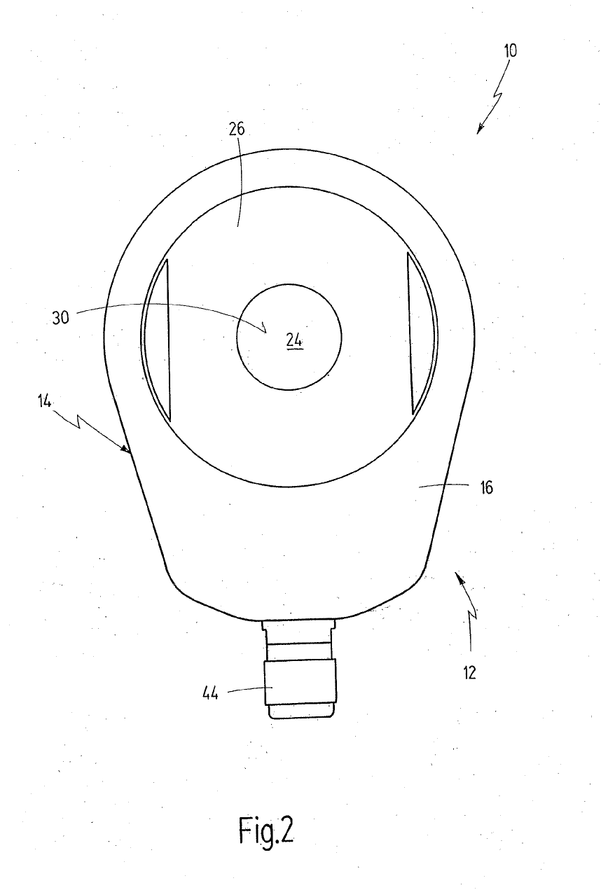

In FIGS. 1 to 3, a medical apparatus for treatment of the human or animal body by pressure waves or shock waves is designated overall by reference number 10. The apparatus 10 is used in particular for the treatment of pain or generally for the treatment of biological tissue in the body of a patient.

The apparatus 10 has a handpiece 12, which is of a compact structure, in particular with a substantially L-shaped design.

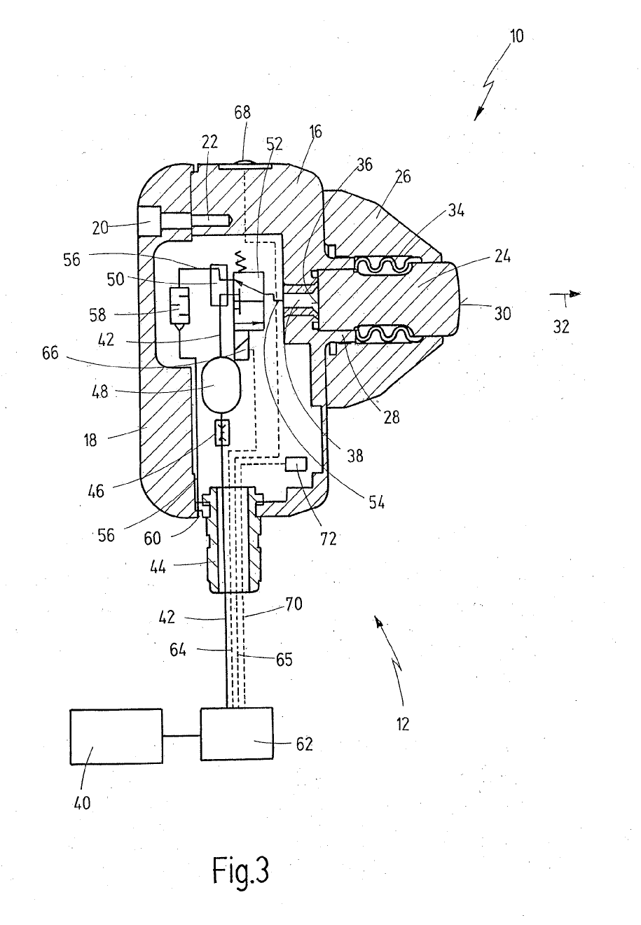

The handpiece 12 has a housing 14 which, in the illustrative embodiment shown, is formed by a main part 16 of the housing and by a housing lid 18, wherein the housing lid 18 is connected to the main part 16 of the housing in a detachable manner. According to FIG. 3, a screw seat 20 is provided in the housing lid 18, and a threaded bore 22 is provided in the main part 16 of the housing, such that the housing lid 18 can be screwed onto the main part 16 of the housing.

The apparatus 10 also has a device which is designed to generate pressure waves or shock waves and which is described in more detail below.

The device for generating the pressure waves or shock waves has in the first instance an applicator part 24, which is mounted in the housing 14, more specifically in the main part 16 of the housing. In order to fix the applicator part 24 on the housing 14, an applicator retention head 26 is provided which is screwed onto a threaded extension piece 28 of the main part 16 of the housing. The applicator retention head 26 is conical on the outside.

The applicator part 24 has an outwardly protruding distal output face 30 by way of which the pressure waves or shock waves can be applied into the body of a patient.

The applicator part 24 in the handpiece 12 or housing 14, including the applicator retention head 26, is movable in the distal direction by a limited stroke, in the direction of arrow 32, the applicator part 24 being shown in its proximal starting position in FIG. 3. The applicator part 24 is elastically pretensioned in the proximal starting position by a restoring element 34. In the illustrative embodiment shown, the restoring element 34 is designed as a bellows-like spring.

The stroke of the applicator part 24 is less than 10 mm, preferably less than 5 mm.

The device for generating the pressure waves or shock waves also has a pneumatic drive, which is described in more detail below.

The pneumatic drive uses a pressurized gas which applies impacts, in the form of individual gas pressure pulses, to the applicator part 24 in order to generate the pressure waves or shock waves in the applicator part 24. The individual gas pressure pulses act directly on the applicator part 24, specifically on a proximal input face 36 of the applicator part 24. A gas delivery channel 38, via which the individual gas pressure pulses are directed to the proximal input face 36 of the applicator part 24, opens out in the direct vicinity of the proximal input face 36.

The proximal input face 36 of the applicator part 24 has a large surface area, for example a surface area of at least 0.5 cm², preferably of at least 1 cm². Whereas, by way of contrast, the gas delivery channel 38 according to FIG. 3, at a distance from the input face 36, has a cross section that is smaller than the input face 36, the gas delivery channel 38 widens in the direct vicinity of the input face 36, such that the gas pressure pulses act as far as possible on the entire input face 36 of the applicator part 24.

To ensure that the gas delivered in the form of gas pressure pulses via the gas delivery channel 38 does not escape undesirably, and thereby to ensure that the full force of the gas pressure pulses can act on the applicator part 24, the applicator part 24 is mounted in a gas-tight manner in the housing 14. For this purpose, seals (not shown in detail) are provided on the applicator part 24 and/or on the housing 14.

The gas is made available in a pressurized gas source 40. The pressurized gas source 40 can be a compressor for compressing gas, for example air, or a gas canister filled with a gas, or a comparable pressure reservoir.

The pressurized gas is delivered to the handpiece 12 via a delivery conduit 42, for example a compressed air hose. The delivery conduit 42 is shown only schematically in FIG. 3. To attach the delivery conduit 42 in the form of a compressed air hose, the housing 14 of the handpiece 12 is provided with a connector piece 44. In the area of the connector piece 44 there is a coupling 46, which here schematically represents the divide or connecting point between the delivery conduit 42, which comes from the outside, and the other gas conduits (still to be described) which are located inside the handpiece 12.

In the further course of the gas delivery, a reservoir 48 can be provided in which a quantity of pressurized gas can be temporarily stored. From the reservoir 48, the delivery conduit 42 leads onwards to a distributor 50 for compressed air delivery and for exhaust air, the distributor 50 being connected to a valve 52, which is designed in particular as a solenoid valve.

Depending on its switching status, the valve 52 connects a gas conduit 54 alternately to the delivery conduit 42 or to a gas discharge conduit 56.

The gas conduit 54 opens into the gas delivery channel 38.

The gas discharge conduit 56 has a sound absorber 58 that damps the noises occurring during the flow of gas. The sound absorber 58 has one or more chambers, which are filled or lined with a soundproofing material.

Further on, the gas discharge conduit 56 opens out of the housing 14, for example at a location 60.

In order to apply individual gas pressure surges to the applicator part 24, the pressurized gas is delivered in bursts into the delivery channel 38 via the delivery conduit 42 and the distributor 50, with the valve 52 being repeatedly opened briefly in the delivery direction, whereupon the individual gas pressure pulses each act on the proximal input face 36 of the applicator part 24 and generate pressure waves or shock waves in the applicator part 24, which pressure waves or shock waves then emerge from the output face 30 and are applied into the body. For this purpose, the output face 30 is placed onto the surface of the body. The gas pressure pulses also cause a stroke or oscillation of the applicator part 24.

The frequency, the amplitude and/or the duration of the individual gas pressure pulses are forcedly controlled by the valve 52. After each gas pressure pulse, the valve 52 closes in the delivery direction and opens in the discharge direction, such that the gas, after each gas pressure pulse, is able to escape from the housing 14 via the discharge conduit 56 and the sound absorber 58.

The apparatus also comprises a control device 62 to which the handpiece 12 can be connected. The control device 62 controls all the main functions of the handpiece 12. The control device 62 also controls the gas delivery from the pressurized gas source 40 to the delivery conduit 42.

The control device 62 is connected to a control head 66 of the valve 52 via a first control line or signal line 64, in order to correspondingly switch the valve 52.

A second control line or signal line 65 connects the control device 62 to a trigger 68. The trigger 68 is arranged on the handpiece 12 at an ergonomically favourable position, such that it can be actuated, for example, by the thumb or index finger of the same hand that is holding the handpiece 12. The trigger 68 is designed as a push-button.

By actuation of the trigger 68, the gas pressure pulses are triggered that act on the applicator part 24. By actuation of the trigger 68, the control device 62 switches the valve 52 according to the set parameters of frequency, amplitude and/or duration of the gas pressure pulses that are to be generated. Provision can be made for only a single gas pressure pulses to be generated when the trigger 68 is actuated, but it is preferable for a continuous sequence of gas pressure pulses to be generated with the trigger 68 permanently actuated.

The control device 62 is connected via a further control line or signal line 70 to an identification circuit 72 of the handpiece 12, which identification circuit 72 makes it possible for the control device 62 to detect the handpiece to which the control device 62 is in fact connected. The reason for this is that, in the context of the invention, it is possible to provide a plurality of different handpieces 12 that differ from each other, for example in terms of the respective applicator part 24 and/or the valve 52. By means of this handpiece identification, the control device 62 is able to predefine certain parameter ranges, for example the duration, frequency and/or amplitude of the gas pressure pulses that are to be generated and that are required in order to generate the pressure waves or shock waves in the respective applicator 24, so as to achieve a specific effect thereof.

However, it is also possible, in a manner not shown here, to provide the handpiece 12 or the control device 62 with operating elements that can be used to change or adjust the aforementioned parameters of the gas pressure pulses even during the operation of the apparatus 10.

The applicator part 24 is arranged exchangeably on the handpiece 12 and, in order to exchange said applicator part 24, only the applicator retention head 26 has to be loosened or removed.

The applicator part 24 is made in particular from a material of low specific weight, for example a light metal, plastic or wood. Examples of light metals that can be used are aluminium or titanium, and examples of plastics that can be used are PMMA (polymethyl methacrylate), PEEK (polyether ether ketone) or a softer plastic.

The mass of the entire handpiece 12 is preferably less than 700 g. The ratio of the mass of the applicator part 24 to the mass of the handpiece is preferably less than 1:25, preferably less than 1:50.

In the case of the applicator part 24 being exchangeable, a plurality of applicator parts 24 are preferably provided which differ from each other in terms of size, mass, material, shape of the distal output face 30 and/or size of the distal output face 30. In this way, it is possible to use the applicator part 24 that is the most favourable for the intended treatment of the patient.

It is also possible for the output face 30 of the applicator part 24 to have a shape that has different dimensions in different directions transverse to the longitudinal direction (corresponding to the arrow 32 in FIG. 3), with the result that the size of the contact area between the output face 30 and the surface of the body of the patient differs depending on the orientation of the handpiece 12 and applicator 24 relative to said surface of the body. For example, the output face 30 can be oval or elliptic. However, it will be appreciated that the output face 30 can also be round. In the illustrative embodiment shown, the output face 30 also has a convex curvature.

While the illustrative embodiment of the medical apparatus 10 shown in the drawing is suitable in particular for treatment of pain in soft-tissue areas near bone, the applicator part 24 can be designed as a thin and long probe for other uses of the apparatus 10, for example for crashing stones in the body, with the result that the applicator part 24 can, for example, be inserted into the body through the urinary tract.

Other fields of use are possible by means of suitable adaptation of the applicator part 24, for example a use for driving nails into bone, for removing bone cement, etc.

While the applicator part 24 in the illustrative embodiment shown here is designed in one piece, it will be appreciated that the applicator part 24 can also be designed in several pieces, for example also made of several different materials.

What is claimed is:

1. A medical apparatus for treatment of the human or animal body by pressure waves or shock waves, comprising
a device designed to generate said pressure waves or shock waves, said device having
at least one applicator part having a proximal input face and a distal output face, and
a pneumatic drive which, by means of pressurized gas, repeatedly generates impacts on said proximal input face of said applicator part in order, with said applicator part, to generate pressure waves or shock waves that are applied from said applicator part into said body by way of said distal output face,
wherein said pressurized gas acts, in the form of individual gas pressure pulses, directly on said applicator part to generate said pressure waves or shock waves.

2. The apparatus of claim 1, further comprising a housing, wherein said applicator part is mounted in a gas-tight manner in said housing.

3. The apparatus of claim 1, wherein said applicator part is movable in distal direction by a limited stroke and is pretensioned elastically in a proximal starting position.

4. The apparatus of claim 3, wherein said limited stroke of said applicator part is less than 10 mm.

5. The apparatus of claim 1, wherein said proximal input face of said applicator part, on which said gas pressure pulses act, measures at least 0.5 cm².

6. The apparatus of claim 1, wherein said applicator part is made from a material of low specific weight.

7. The apparatus of claim 1, wherein said gas pressure pulses are controlled by at least one valve.

8. The apparatus of claim 7, wherein said at least one valve is a solenoid valve.

9. The apparatus of claim 1, wherein said apparatus has a handpiece that comprises said at least one applicator part.

10. The apparatus of claim 9, wherein said handpiece has a mass of less than 700 g.

11. The apparatus of claim 9, wherein a ratio of mass of said handpiece to mass of said applicator part is greater than 25:1.

12. The apparatus of claim 9, wherein a trigger for triggering said gas pressure pulses in single operation or continuous operation is arranged on said handpiece.

13. The apparatus of claim 9, wherein said handpiece can be connected to a control device, in which case a plurality of handpieces are provided, and said control device detects the handpiece to which said control device is connected.

14. The apparatus of claim 7, wherein said apparatus has a handpiece that comprises said at least one applicator part, and wherein said at least one valve is arranged in said handpiece.

15. The apparatus of claim 1, wherein at least one of a frequency, an amplitude, a duration of said gas pressure pulses is adjustable.

16. The apparatus of claim 9, wherein at least one of a frequency, an amplitude a pressure of said gas pressure pulses can be adjusted on said handpiece.

17. The apparatus of claim 1, wherein said applicator part is exchangeable.

18. The apparatus of claim 17, wherein several applicator parts are provided which differ from one another in terms of at least one of size, mass, material, shape of said distal output face, size of said distal output face.

19. The apparatus of claim 1, wherein said output face of said applicator part has a shape that has a different dimension in different directions transverse to a longitudinal direction of said applicator part.

20. The apparatus of claim 19, wherein said output face is oval or elliptic.

21. The apparatus of claim 1, wherein said apparatus is soundproofed.

22. The apparatus of claim 1, wherein said applicator part is made from a plurality of different materials.

23. The apparatus of claim 1, wherein a frequency of said gas pressure pulses is greater than 20 Hz.
